(19) United States
(12) Patent Application Publication
(10) Pub. No.: US 2015/0178509 A1
(43) Pub. Date: Jun. 25, 2015

(54) TRIGGER BASED PORTABLE DEVICE MORPHING

(71) Applicant: International Business Machines Corporation, Armonk, NY (US)

(72) Inventors: Anjil R. Chinnapathlolla, Bangalore (IN); Rajaram B. Krishnamurthy, Wappingers Falls, NY (US); Daniel Rogers, Port Ewen, NY (US)

(21) Appl. No.: 14/502,408

(22) Filed: Sep. 30, 2014

Related U.S. Application Data
(63) Continuation of application No. 14/138,728, filed on Dec. 23, 2013.

(51) Int. Cl. G06F 21/60; H04L 29/08

(52) U.S. Cl. CPC G06F 21/604; H04L 67/18; H04L 67/30

(57) ABSTRACT

Embodiments relate to morphing a portable device. An aspect includes a method including executing an application among a set of applications of the portable device to obtain an input, and comparing, using a processor, the input to a plurality of triggers. The method also includes activating, using the processor, a profile of the portable device, based on the input matching one of the plurality of triggers, the profile corresponding with the one of the plurality of triggers and being one of a plurality of profiles, each of the plurality of profiles defining enabled applications, security settings for information access by the portable device, and redundancy settings of the portable device including frequency of document backup.

This application is a continuation of U.S. application Ser. No. 14/138,728 filed Dec. 23, 2013, the disclosure of which is incorporated by reference herein in its entirety.

### BACKGROUND

The present invention relates generally to morphing a portable device profile, and more specifically, to trigger based portable device morphing.

Portable devices (e.g., smartphone, tablet) are lightweight communication and computation devices that interact wirelessly over a cellular network, WiFi, an enterprise network, or other medium. For example, smartphones may be thought of as cellular phones with additional functionalities and applications. Some of the additional functionalities and applications include a global positioning system (GPS) receiver, camera, internet access, and all of the additional capabilities that entails. The capabilities facilitated by portable devices include the ability to do many of the things in a work environment that were previously done by computers at a work site. For example, portable devices allow a user to access an enterprise email system or enterprise servers and databases that require user authentication for the access. Thus, the user may access work-related documents for viewing or editing or access a work email account using the portable device, for example.

Because users may use the same portable device for both work and personal use, the ability to change aspects of the device based on the current use can be desirable. Smartphones allow users to change look and feel settings such as the display and ring tone, for example. Some of the changes may be bundled into a particular predefined profile. Thus, as one example, a user may choose options to establish a “meeting” profile which, when activated, may dim the display and silence ringtones, putting the device in a vibrate mode. In some cases these bundled preselected features (profiles) may be automatically activated. For example, because portable devices include a GPS receiver, a specific profile may be set to become activated within a predefined GPS location-specified area.

### SUMMARY

Embodiments include a method of morphing a portable device is also described. The method includes executing an application among a set of applications of the portable device to obtain an input. The method also includes comparing, using a processor, the input to a plurality of triggers, and activating, using the processor, a profile of the portable device, based on the input matching one of the plurality of triggers, the profile corresponding with the one of the plurality of triggers and being one of a plurality of profiles, each of the plurality of profiles defining enabled applications, security settings for information access by the portable device, and redundancy settings of the portable device including frequency of document backup.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts components of a portable device in accordance with an embodiment;

FIG. 2 depicts a block diagram of a morph engine in accordance with an embodiment;

FIG. 3 depicts a process flow for morphing a portable device in accordance with an embodiment;

FIG. 4 illustrates a portable device with an exemplary profile according to an embodiment; and

FIG. 5 illustrates a portable device with another exemplary profile according to an embodiment.

### DETAILED DESCRIPTION

As noted above, portable devices (e.g., smartphones, tablets) may be used in different contexts, such as for work, during travel, and for personal use, for example. Users may currently bundle certain look and feel type functionalities such as display and ring tone into a profile. The user may manually or automatically activate a predefined profile. Automatic activation of the profile may be based on GPS location and, additionally, on a time period. For example, when a user is in a movie theater, the event notification functionality may be disabled for a time period equal to the duration of the movie. A user may also activate a particular application based on a certain condition. For example, an accelerometer within the portable device may be associated with different profiles such that a map application is activated when it is determined (through the accelerometer) that the user is walking and a media player is activated when it is determined (through the accelerometer) that the user is jogging.

Embodiments detailed herein relate to trigger based morphing of a portable device. The morphing refers to reconfiguring the portable device or activating a profile that is more comprehensive than merely changing the look and feel or enabling of one or more applications of the device. The morphing activates a profile that defines a particular quality of service provided by the device. Morphing may also include a change in physical appearance of the device. Quality of service refers to a predefined level of security, reliability, and redundancy, as well as functionality. Thus, as detailed below, a trigger causes the portable device to morph to a profile defining a particular quality of service.

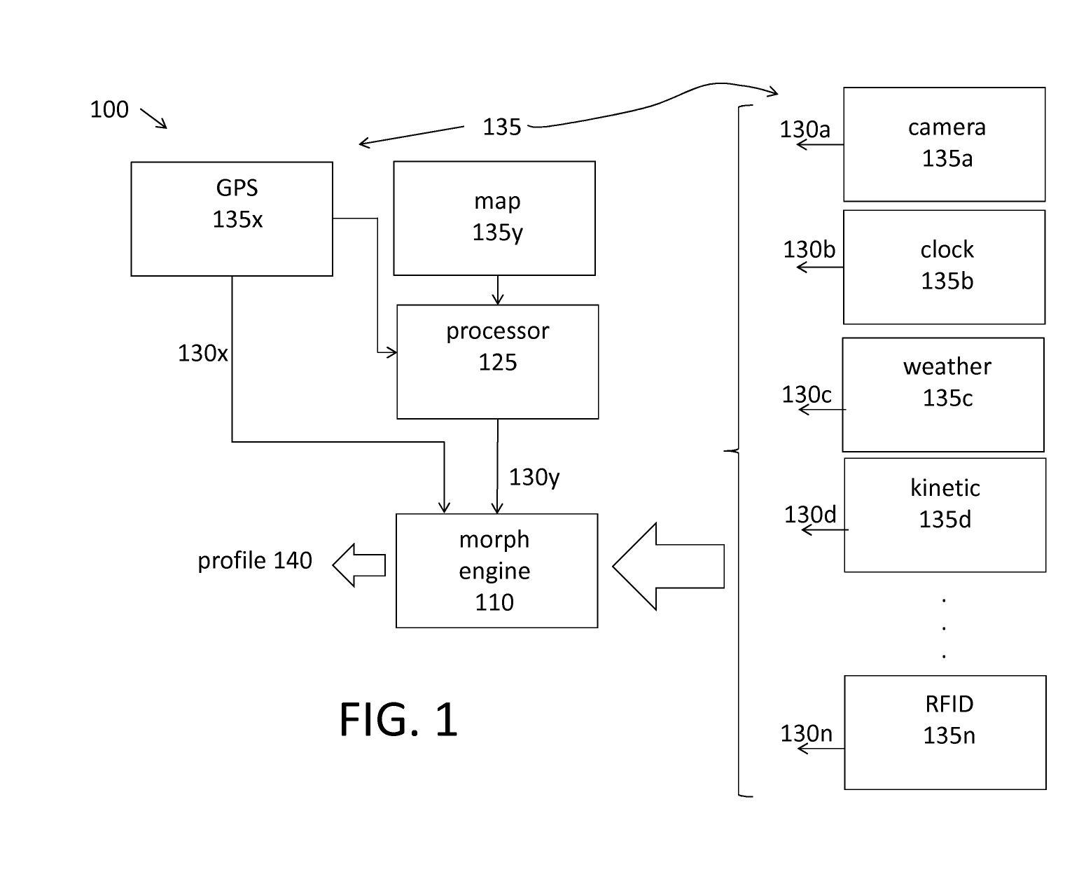

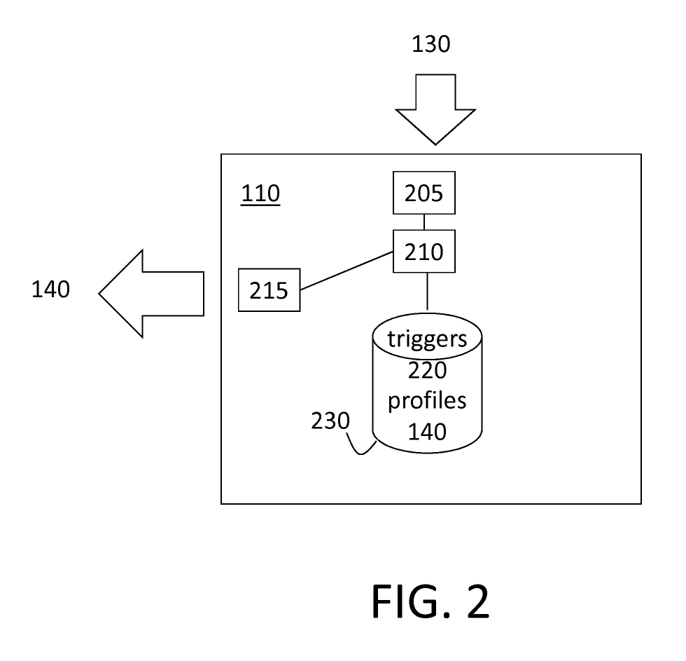

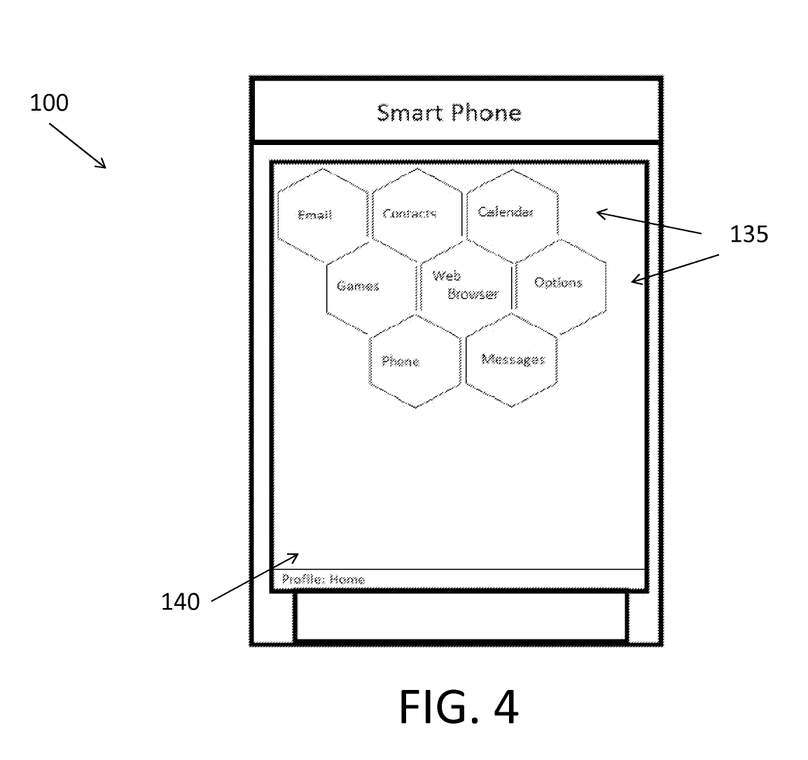

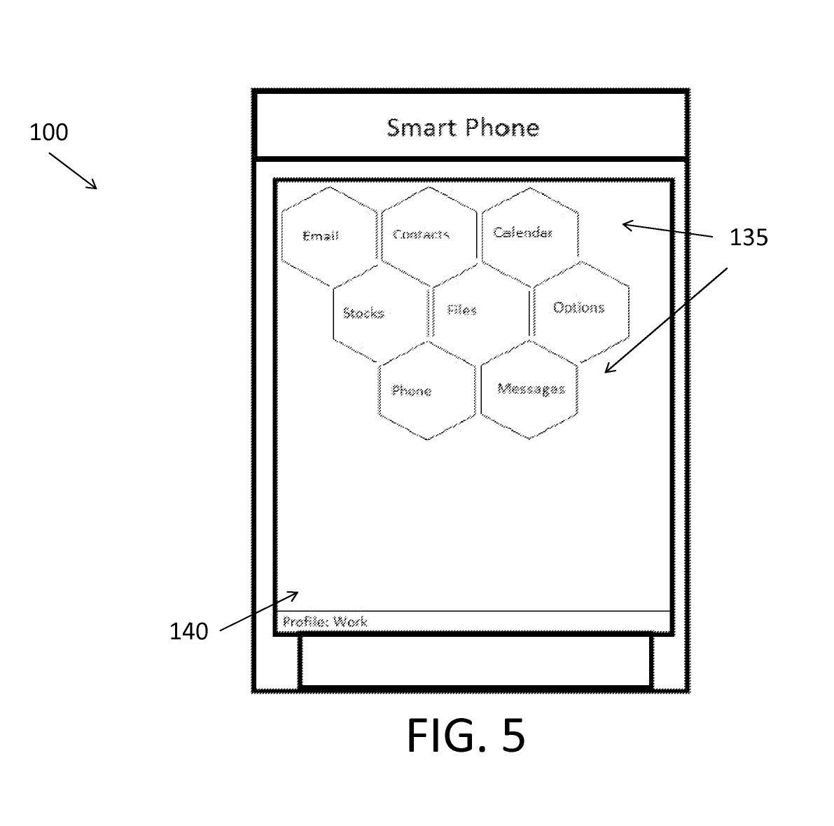

Turning to FIG. 1, components of a portable device 100 are generally shown. The morph engine 110 facilitates the trigger based morphing of the portable device 100 and is detailed further with reference to FIG. 2. The morph engine 110 receives one or more inputs 130 and compares the inputs 130 against a set of triggers 220 (FIG. 2). If any of the inputs 130 received by the morph engine 110 match any of the triggers 220, the morph engine 110 outputs a corresponding profile 140. Each profile 140 defines enabled applications, security settings for information access by the portable device 100, and redundancy settings of the portable device, which include frequency of document backup, for example. Illustrative examples of profiles 140 and additional details of profiles 140 (including split profiles and hybrid profiles) are discussed below with reference to FIGS. 4 and 5. The triggers 220 and profiles 140 may be defined in correspondence with each other. Alternately or additionally, a trigger 220 may be added to a predefined profile 140. A given profile 140 may have more than one corresponding trigger 220. The triggers 220 and profiles 140 may be defined in a number of ways. Triggers 220 and profiles 140, together or separately, may be defined by the user of the portable device 100, for example. Additionally or alternately, triggers 220 or profiles 140 may be predefined by an enterprise providing the portable device 100 or by the manufacturer or service provider associated with the portable device 100, for example. In an exemplary case, if a company provides portable devices 100 to its employees, the company may define one or more triggers 220 to activate a work-related profile 140 that may not be changed by the employees.

The inputs 130 to the morph engine 110 are outputs of some or all of a set of applications 135 executed by the portable device 100. The portable device 100 may include any number applications 135 that are implemented by one or more processors (e.g., 125). For example, a global positioning system (GPS) application 135x may provide, as an input 130x, the position of the portable device. Alternatively or additionally, the position may be processed (processor 125) along with a map from a map application 135y to obtain a location of the portable device 100 as an input 130y. While the position input 130x provides coordinates in the GPS mapping system, the location input 130y provides a location (e.g., public library) according to a map of the area in which the portable device 100 is currently operating. Another exemplary input 130a is provided by a camera application 135a. The input 130a may be an image obtained using the camera application 135a or may be an identification of an object in the image determined using image processing. A clock application 135b may provide current time or a duration as an input 130b. A weather application 135c may provide temperature or other weather-related information as an input 130c. A kinetic application 135d may be associated with an accelerometer, for example, and may provide information about movement of the portable device 100 as an input 130d. A radio frequency identification (RFID) application 135n may be used to read an RFID tag on an object and may provide information related to the RFID tag (e.g., identification, location, status) as an input 130n. The above-discussed exemplary applications 135 and the inputs 130 that they provide are not intended to be limiting. For example, the signal strength of the cellular signal of the portable device 100 is another input 130. The inputs 130 defined as triggers 220 are only limited by the applications 135 that are available for a given portable device 100. As noted above, only some of the applications 135 may provide an input 130 to the morph engine 110 according to one or more embodiments. In these embodiments, a pre-processing may ensure that the comparison with triggers 220 is not made for inputs 130 that are known not to be triggers 220. That is, all applications 135 associated with defined triggers 220 may be tracked such that outputs provided by applications 135 that are not associated with defined triggers 220 bypass the morph engine 110 (are not inputs 130 to the morph engine 110). In other embodiments, all outputs provided by all applications 135 may be treated as inputs 130 by the morph engine 110.

FIG. 2 depicts a block diagram of the morph engine 110 in accordance with an embodiment. The morph engine 110 includes an input interface 205, an output interface 215, a processor 210 and one or more memory devices 230, also referred to as one or more databases 230, that store the triggers 220 and corresponding profiles 140. The processor 210, also referred to as processing circuit 210, may be a processor shared by other functions of the portable device 100 rather than being a separate processor for the exclusive use of the morph engine 110. The memory device 230 may be shared by other functions of the portable device 100, as well. As noted above, the input 130 provided by any application 135 of the portable device 100 may be defined as a trigger 220 for a corresponding profile 140. More than one trigger 220 may correspond with the same profile 140. In addition, two or more inputs 130 may be combined to define a single trigger 220. For example, both a location input 130y and time input 130b may be combined as a trigger 220 for a profile 140 associated with work. This example illustrates inputs 130 that may be provided periodically at regular or irregular intervals. That is, while a camera application 135a may only provide an image as an input 130a based on user execution of the camera application 135a, the location 130y and time 130b may be updated and provided to the morph engine 110 as new inputs 130 regularly without user intervention. Thus, when a new location input 130y is provided to the morph engine 110, for example, the morph engine 110 may use the most recently received time input 130b in conjunction with the location input 130y to compare with the exemplary trigger 220. Each trigger 220 is a rule. For example, the exemplary trigger 220 discussed above may be a rule such as “if the location input 130y is the office and the time input 130b is within a range of 9 a.m. to 5 p.m.”

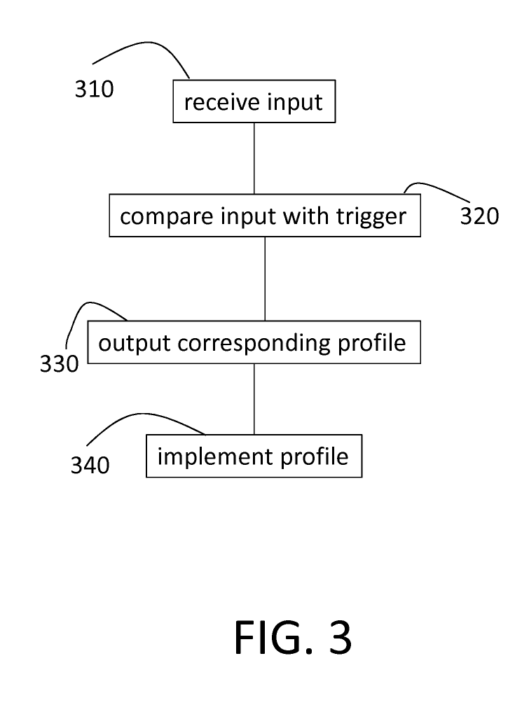

FIG. 3 depicts a process flow for morphing a portable device 100 in accordance with an embodiment. At block 310, receiving the input 130 includes receiving the result of executing one or more applications 135 of the portable device 100 at the input interface 205 of the morph engine 110. In alternate embodiments, pre-processing may ensure that only the result of executing applications 135 associated with triggers 220 are received as inputs 130 at the input interface 205. At block 320, comparing inputs 130 with triggers 220 is done by the morph engine 110. As noted above, one, two, or more inputs 130 may define a given trigger 220. Outputting (using the output interface 215 of the morph engine 110) the corresponding profile 140 at block 330 occurs when an input 130 matches a trigger 220 associated with the profile 140. At block 340, implementing the profile 140 output by the morph engine 110 includes making changes to the applications that are active, to security settings, and to redundancy settings, as needed. The changes may be implemented by one or more processors of the portable device 100. It bears noting that an input 130 may correspond with the same trigger 220 as the previous input 130 such that the profile 140 output by the morph engine 110 is the same profile 140 previously output by the morph engine 110. In alternate embodiments, the morph engine 110 may only output a profile 140 when it is a different profile 140 than the last one output by the morph engine 110. In other alternate embodiments, the processor or processors that implement the profile 140 output by the morph engine 110 may recognize that no changes are needed when the profile 140 is the same as the previous profile 140. Implementing the profile 140 at block 340 may additionally include providing an option to the user to change the profile 140 to the one corresponding to the input 130 or to maintain the current profile 140.

In additional or alternate embodiments, morphing to a particular profile 140 may include a change in physical appearance of the portable device 100. For example, the security settings of a particular profile 140 may include rendering the device case to be physically shut. An application 135 associated with a profile 140 may include one that changes the exterior “skin” of the portable device 100 to a user selected color or, based on a user selection, a pattern or shade matching the user's clothing or objects in the vicinity of the portable device 100. That is, according to a particular trigger 220, a profile 140 may be selected that activates an application that periodically or continuously changes the portable device 100 outer appearance based on the surroundings.

FIG. 4 illustrates a portable device 100 with an exemplary profile 140 according to an embodiment. FIG. 4 shows the applications 135 associated with a profile 140 defined as “home.” FIG. 5 illustrates a portable device 100 with another exemplary profile 140 according to an embodiment. FIG. 5 shows the applications 135 associated with a profile 140 defined as “work.” Each of the profiles 140 includes a security and redundancy setting for the different applications 135 accessible through the profile 140. A comparison of FIG. 4 and FIG. 5 indicates that the home profile 140 in FIG. 4 includes a home email application 135 while the work profile 140 in FIG. 5 includes a work email application 135. The security settings may be different according to each of the profiles 140. For example, the email application 135 available in the work profile 140 (FIG. 5) may require a password while the email application 135 available in the home profile 140 (FIG. 4) may not require a password. As another example, files in the home profile 140 may be stored at a lower encryption level than files in the work profile 140. Additionally, as an example, files in the work profile 140, when being used at a work location, may be stored at a lower encryption level for higher performance. When the portable device 100 is moved to a location outside a work site (another profile 140 is activated), the files may be re-encrypted with higher levels of encryption. The games applications 135 and web browser application 135 available in the home profile 140 are not available in the work profile 140. The work profile 140 includes a stocks application 135 and a files application 135 that are not available in the home profile 140. The files accessible through the files application 135 may be encrypted. In addition, the profile 140 may define the frequency at which the files and related documents are backed up. Additional redundancy settings may be applied as part of a given profile 140, as well. For example, as part of a profile 140 triggered when the portable device 100 is at a work location, multiple copies of an application that is being executed may be run on different processor cores so that if one copy of the application malfunctions and crashes, the second copy of the application can service the user seamlessly. Additionally, files or storage in a work profile 140 may be stored on multiple storage devices or storage locations of the portable device 100 to enable enhanced recovery and promote higher file redundancy levels.

Two special types of profiles 140 that may be defined and associated with one or more triggers 220 are the split profile 140 and hybrid profile 140. The split profile 140 and hybrid profile 140 are based on the ability to use previously defined profiles 140 to further define additional profiles 140. A split profile 140 includes a foreground profile 140 and a background profile 140, and a hybrid profile is a combination of two individually defined profiles 140. For example, in addition to the home profile 140 illustrated in FIG. 4 and the work profile 140 illustrated in FIG. 5, a split profile 140 may be defined that has the work profile 140 in the foreground and the home profile 140 in the background. This would mean that the applications 135 (e.g., games, web browser) that are not available when the work profile 140 alone is activated are available in the split profile 140. Running the home profile 140 in the background may affect the number of processor cores dedicated to the applications 135 associated with the profile 140, for example. Running the home profile 140 in the background may also affect the applications 135 that are visible on the primary screen, for example. According to an embodiment of the split profile 140, applications in the home profile 140 and work profile 140 may be operated in concert. For example, a map application 135 in the home profile 140 may route a user to a work location, and a map application 135 in the work profile 140 can be used to route a user within the work location (e.g., within an office building). The map application 135 in the home profile 140 would pass information to the map application 135 in the work profile 140 to enable this functionality. The profiles may be switched between foreground and background for this to work. In contrast to a split profile 140, a hybrid profile 140 treats the applications 135 associated with the profiles 140 used in the combination equally. Thus, if the home profile 140 shown in FIG. 4 and the work profile 140 shown in FIG. 5 were combined into a hybrid profile, for example, both the home email application 135 and the work email application 135 would be visible in the primary screen. In addition, games and the web browser applications 135, as well as stocks and files applications 135, would all be available and processed by the same number of processor cores of the portable device 100. As an example, in order that the home profile 140 and work profile 140 be co-resident and simultaneously active in a hybrid profile 140, rules may be defined that allow certain features in one of the profiles 140 to be preferred over those of the other profile 140. For example, when a work profile 140 and a home profile 140 are operated in hybrid fashion file security and redundancy settings from the work profile 140 may carry over to all storage operations across both profiles 140.

Technical effects and benefits include the ability to activate, automatically or with user permission, a profile 140 defining enabled applications, security settings, and redundancy settings based on definable triggers 220.

As will be appreciated by one of average skill in the art, aspects of embodiments may be embodied as a system, method or computer program product. Accordingly, aspects of embodiments may take the form of an entirely hardware embodiment, an entirely software embodiment (including firmware, resident software, micro-code, etc.) or an embodiment combining software and hardware aspects that may all generally be referred to herein as, for example, a “circuit,” “module” or “system.” Furthermore, aspects of embodiments may take the form of a computer program product embodied in one or more computer readable storage device(s) having computer readable program code embodied thereon.

One or more of the capabilities of embodiments can be implemented in software, firmware, hardware, or some combination thereof. Further, one or more of the capabilities can be emulated.

An embodiment may be a computer program product for enabling processor circuits to perform elements of the invention, the computer program product comprising a computer readable storage medium readable by a processing circuit and storing instructions for execution by the processing circuit for performing a method.

The computer readable storage medium (or media), being a tangible, non-transitory, storage medium having instructions recorded thereon for causing a processor circuit to perform a method. The “computer readable storage medium” being non-transitory at least because once the instructions are recorded on the medium, the recorded instructions can be subsequently read one or more times by the processor circuit at times that are independent of the time of recording. The “computer readable storage media” being non-transitory including devices that retain recorded information only while powered (volatile devices) and devices that retain recorded information independently of being powered (non-volatile devices). An example, non-exhaustive list of “non-transitory storage media” includes, but is not limited to, for example: a semi-conductor storage device comprising, for example, a memory array such as a RAM or a memory circuit such as latch having instructions recorded thereon; a mechanically encoded device such as punch-cards or raised structures in a groove having instructions recorded thereon; an optically readable device such as a CD or DVD having instructions recorded thereon; and a magnetic encoded device such as a magnetic tape or a magnetic disk having instructions recorded thereon.

A non-exhaustive list of examples of computer readable storage medium include the following: a portable computer diskette, a hard disk, a random access memory (RAM), a read-only memory (ROM), an erasable programmable read-only memory (EPROM or Flash memory), a portable compact disc read-only memory (CD-ROM). Program code can be distributed to respective computing/processing devices from an external computer or external storage device via a network, for example, the Internet, a local area network, wide area network and/or wireless network. The network may comprise copper transmission cables, optical transmission fibers, wireless transmission, routers, firewalls, switches, gateway computers and/or edge servers. A network adapter card or network interface card in each computing/processing device receives a program from the network and forwards the program for storage in a computer-readable storage device within the respective computing/processing device.

Computer program instructions for carrying out operations for aspects of embodiments may be for example assembler code, machine code, microcode or either source or object code written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable storage medium that can direct a computer, other programmable data processing apparatus, or other devices to function in a particular.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of morphing a portable device, the method comprising:
executing an application among a set of applications of the portable device to obtain an input;
comparing, using a processor, the input to a plurality of triggers; and
activating, using the processor, a profile of the portable device, based on the input matching one of the plurality of triggers, the profile corresponding with the one of the plurality of triggers and being one of a plurality of profiles, each of the plurality of profiles defining enabled applications, security settings for information access by the portable device, and redundancy settings of the portable device including frequency of document backup.

2. The method according to claim 1, wherein the executing the application to obtain the input includes executing a global positioning system (GPS) application to obtain a position of the portable device and also includes processing the position using a map to obtain a location of the portable device.

3. The method according to claim 1, wherein the executing the application to obtain the input includes executing a camera application to obtain a camera image, executing a weather application to obtain weather-related information, executing a kinetic application to obtain information regarding a movement of the portable device, or executing a radio frequency identification (RFID) application to obtain information regarding an object with an RFID tag.

4. The method according to claim 1, wherein at least one of the plurality of triggers is defined by two or more of the inputs.

5. The method according to claim 1, wherein the comparing is performed following each of the executing of one of the set of applications.

6. The method according to claim 1, wherein the activating the profile includes activating a split profile, the split profile comprising one of the plurality of profiles as a foreground profile and another of the plurality of profiles as a background profile.

7. The method according to claim 1, wherein the activating the profile includes activating a hybrid profile, the hybrid profile comprising a combination of two of the plurality of profiles.
